(19) United States
(12) Patent Application Publication
(10) Pub. No.: US 2002/0071891 A1
(43) Pub. Date: Jun. 13, 2002

(54) Drops in a bucket-method and device for packaging and selling frozen dough

(76) Inventor: John M. Lile, Akron, OH (US)

Correspondence Address: Daniel A. Thomson, 4421 Ranchwood Spur, Akron, OH, 44333-1343, US

(21) Appl. No.: 09/735,195

(22) Filed: Dec. 8, 2000

(51) Int. Cl. A21D 13/00

(52) U.S. Cl. 426/391; 426/552

(57) ABSTRACT

An article and method for improved packaging, delivery and sale of frozen dough products. The article is a plastic-like container having a resealable plastic lid. The container can feature decorative or advertising indicia on its side. The container may include a handle. Dough, such as cookie or muffin dough, is arranged in pre-portioned sized drops, frozen and then stored in the containers. The container can be easily carried, even by children, and therefore is especially suitable for fund raising activities.

### BACKGROUND OF THE INVENTION

1. Field of Invention

This invention pertains to the art of methods for marketing pre-portioned cookie drops in multiple size plastic buckets, and more specifically to methods for use in marketing to schools for fund raising.

2. Description of the Related Art

It is known to sell frozen cookie dough in various containers.

### SUMMARY OF THE INVENTION

In accordance with the present invention, a new and improved method and device for packaging and selling dough is provided.

More particularly, in according with the invention, the method of packaging frozen cookie dough includes the steps of providing a container, the container being made of plastic and having a top edge and a bottom edge. The top edge of the container defines a circle with a radius RT. The bottom edge of the container defines a circle with a radius RB. The radius RT is greater than the radius of the radius RB. The container has a resealable opening at the top edge of the container. The method further provides the step of providing a lid. The lid cooperates with the top edge of the container to selectively seal the container. The method also contains the step of separating uncooked cookie dough into a plurality of drops. The drops are sized so as to create a single portion cookie upon the subsequent step of baking. The method next includes the step of freezing the uncooked, single portioned, cookie drops. The method next comprises the step of placing each of the plurality of drops into the container. Finally, the method comprises the step of sealing the container by operatively connecting it with the lid, so that the lid and the top edge of the container operatively engage in a generally airtight manner so as to provide freshness.

In accordance with another aspect of the invention, an article for containing frozen, proportioned dough comprises a bottom, which is generally circular and has a radius RB. The container also comprises a top edge, which is generally circular and has a radius RT. The container further comprises a sidewall, which extends between the top edge and the bottom. The sidewall is generally cylindrical. The sidewall is also made of plastic and has a resealable opening. The container further comprises lid. The lid is removably attachable to the top edge of the container. The lid selectively, cooperatively engages the top edge of the container to selectively seal the container.

One advantage of the present invention is the provision a new method of packaging frozen cookie dough, or other kinds of dough, which can be used to provide an advantage to the marketplace.

Another advantage of the method is the convenience of pre-packaged, pre-portioned frozen drops of dough, and the provision of those in a resealable, reusable plastic container.

Two other and advantages of the present invention will become apparent to those skilled in the art upon a reading and understanding of the following detailed specifications.

This process would bring proportioned cookie dough greater awareness in the marketplace. Customers would buy for the following reasons: reusable plastic tub that can be used for future food storage; no thawing, spooning, no mess, no re-freezing when you use pre-portioned drops; customers would identify with a popular phrase, “DROPS IN A BUCKET.” This would distinguish our product from bulk cookie dough in a tub. The plastic bucket would provide customers an added value and incentive to purchase the pre-portioned drops. The tubs serve many purposes such as making them into a money collection receptacle and for future school fund raising events. Graphics may be added to tubs depicting school groups, sports leagues and other organizations we presently market to within the fund raising industry. (Also pictures of cookies, etc.) Buckets would streamline the manufacturing process allowing us to be more competitive in the market place. A safety seal could be applied to the lid on a plastic bucket insuring product safety to the end user. A plastic bucket would help to keep the product fresher for a longer period of time. Customers could use drops as needed and reseal the bucket for future product freshness and maximum shelf life. Customers appreciate the consistent size, flavor and quality of pre-portioned cookie drops as well as the freezer to oven convenience, saving them valuable time. Cookie dough would be configured in different sizes per portion, but the most common size would be 1.2 ounce. There would be 40 pieces of pre-portioned dough in a plastic tub in most instances, equally three pounds (3 lbs) per unit. We would probably change size and shapes eventually of the pre-portioned dough to make seasonal shapes, etc, (Easter bunnies, Christmas trees, etc.) The plastic tubs would also be used to communicate messages to the buyer and graphics and text would be added to impress that this product is pre-portioned and will give the customer much more convenience than the traditional bulk tub of dough.

The identification of “DROPS IN A BUCKET”, pre-portioned cookie dough in plastic tubs would help expand the present demand for this product and would help customers identify mentally with this product when it is offered at a future date for sale at a retail store or by a fund raising organization.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and herein:

FIG. 1 is a schematic view of the inventive container and lid, shown in exploded view;

FIG. 2 is a front perspective view of the container of FIG. 1 with a window broken into the side of the container to show the drops of frozen cookie dough; and,

FIG. 3 is a front perspective view of another embodiment of the container showing a handle.

### DESCRIPTION OF THE PREFERRED EMBODIMENT

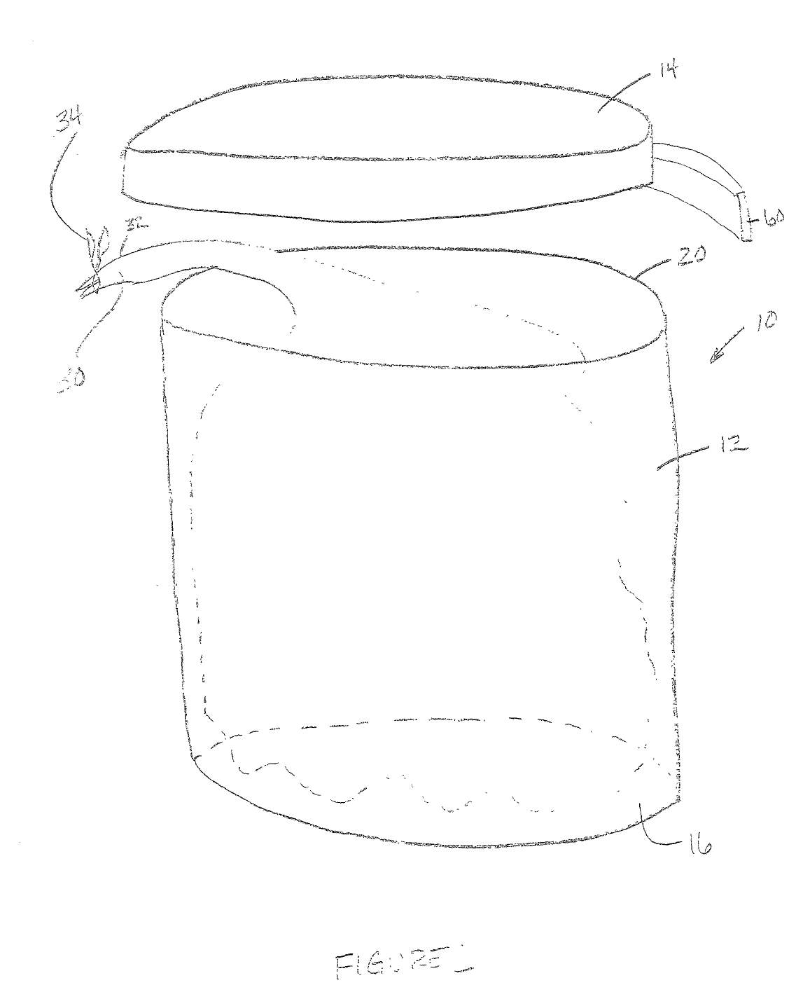

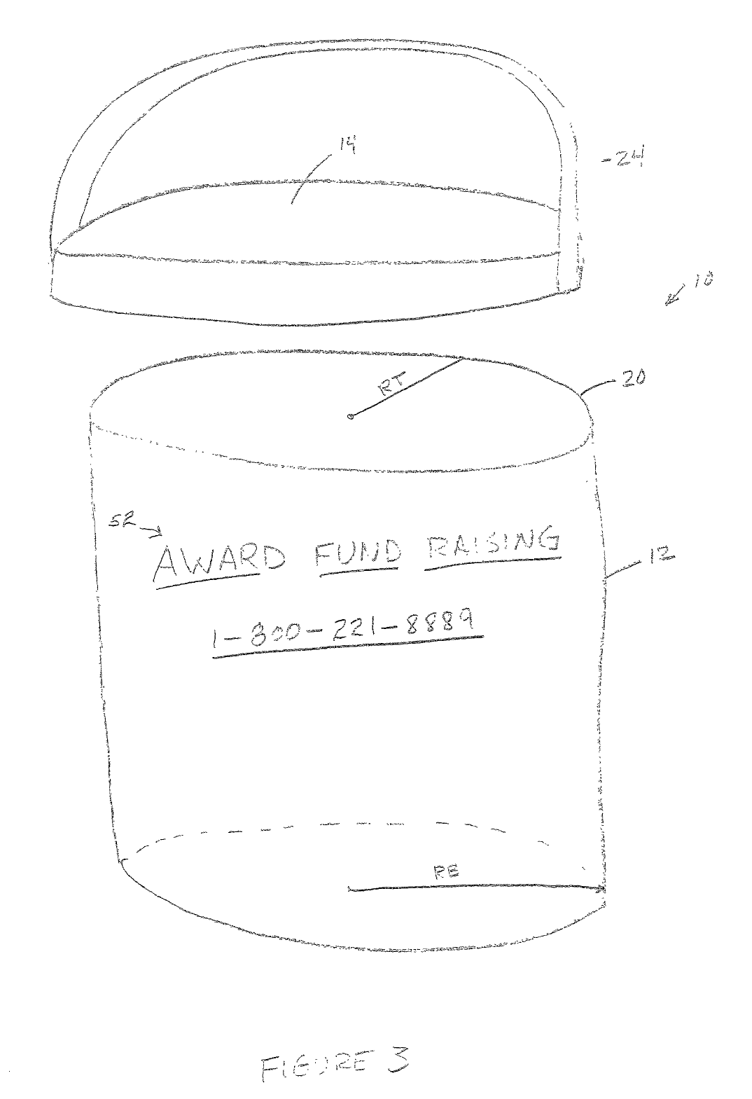

Referring now to the drawings wherein the showings are for purposes of illustrating a preferred embodiment of the invention only and not for purposes of limiting the same, FIG. 1 shows the inventive container 10. The container 10 includes a can portion 12 and a lid 14 The container 10 includes a bottom 16. The bottom is preferably circular, although similar shapes could be used. The bottom has a radius RB, as is illustrated in FIG. 3.

The container 10 also has a top edge 20. The top edge preferably defines a circle, with a circle having a radius RT. In the preferred embodiment RT is greater than RB, meaning the container 10 has generally cylindrical configuration, with a preferred embodiment container 10 varying from a perfect cylinder in that the top of the cylinder (in other words, the top edge 20) is slightly larger than the bottom 16 of the container 10. In this way, the container takes on the more classic shape of a bucket.

The lid 14 is designed so that it seals the container 10. The sealing is done in the conventionally known ways. For example, many plastic products are designed so that the edges can resiliently be formed and mate together to provide a generally airtight seal. Example of such products includes such products include such containers for whipped cream, ice cream, and the like. Other commercially available products, which seal in similar ways, include food storage products sold by Rubbermaid and Tupperware. Any sealing method appropriate for the food industry and the plastic involve, which is chosen with sound engineering judgment, can be utilized. However, it is important that, in the preferred embodiment, that the sealing be able to be repeatably done. In this way, the consumer can open close and reopen close and reopen the container several times, while still maintaining airtight freshness for the products within.

With continuing reference to FIG. 3, in one embodiment of the invention, the lid 14 further comprises a handle 24. The handle 24 is attached to the lid 14 in any way that would be adequate from an engineering standpoint.

The preferred embodiment, the container 10 and lid 14 are made of plastic. Any plastic, conventionally available, which is appropriate for the temperatures and use foreseen is adequate, as long as the plastic is chosen with sound engineering judgment and according to local laws and customs concerning food stuffs. For example, many food products are stored the plastic containers and are frozen. Any of these plastics will work fine is this application.

With a reference to FIG. 1, in one preferred embodiment, the container 10 also includes a bag 30. The preferred bag 30 is made of plastic and it open at a top end 32. The bad 30 can be resealably, selectively closed and opened by means of operating closure means 34. The preferred closure means 34 is a wire twist tie, which is commonly available and used in similar applications. However, other closure means such as binder clip, rubber bands, tying knots in bag itself, or other means of closing the bag 30 can be used. In the preferred embodiment, the bag 30 is inserted into the can portion 12 of the container 10 and then folded or pushed down inside the interior of the can portion 12 of the container 10, so that the lid 14 can be sealing engaged to the top edge 20 of the container 10.

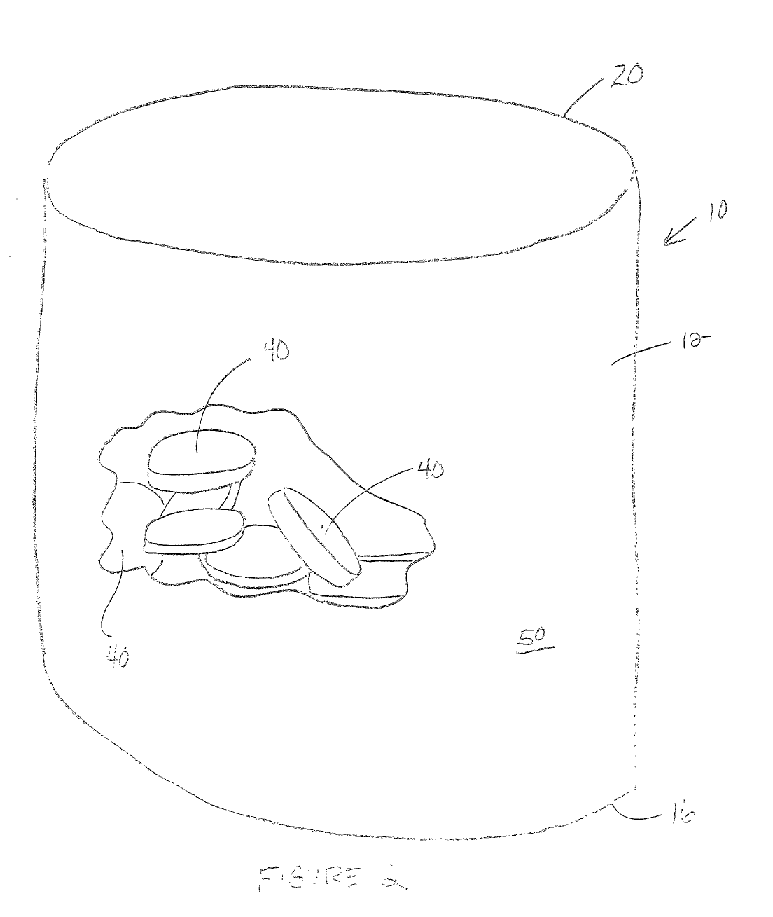

With reference to FIG. 1-3, the innovative method of packaging will now be described. The first step of the innovative method is the provision of a container, which is made out of plastic and has a top edge and a bottom edge. This container is illustrated in FIGS. 1-3. The preferred container has a nearly cylindrically arrangement described previously. After the container is available, dough of the desired variety should be prepared. For the rest of patent of this patent application, the dough referred to will be cookie dough, although any similar uncooked dough to be used in baking could also be prepared. For example, muffin dough is simply dropped into muffin tins could also be prepared and frozen into pre-portioned “muffin drops.”

After the dough is prepared, it is separated into a plurality of drop. The drops are sized so as to create a single portion cookie upon subsequent baking by the purchaser of the product. The drops are then frozen. Next, the drops are gathered and placed into the container 10. In the preferred embodiment, the drops are placed first into bag 30. This can be done by filling the bag 30 with the appropriate amount of drops 40 and then placing the bag 30 filled with drops 40 into the container 10, or, the bag 30 can be first placed into the can portion 12 of the container 10. The top edge 32 of the bag 30 can be opened, in the preferred embodiment placed outside the top edge 20 of the lower can portion 12, and then the drops 40 can be placed into the bag 30, which is simultaneously inside the can portion 12 of the container 10. Next, the container is sealed by closing the top edge 32 of the bag 30 and then by closing the container 10 by seemingly engaging the top edge 20 of the container with the lid 14.

The container tin may also feature a safety-seal to indicate whether or not the package has been opened or otherwise tampered with prior to purchase. A variety of safety-seals can be used. Some safety-seals are of the type where the middle top portion of the lid 14 is depressed by drawing a slight vacuum on the interior contents of the container 10. In this embodiment, the fact that the container 10 has not been tampered with is indicated by the lid 14 being slightly concave inwardly toward the center of the container 10 due to the presence of the slight vacuum. Another safety-seal is illustrated in FIG. 1 where a cut away view of a safety-seal 60 or safety seal strap is illustrated. A portion of the safety-seal strap 60 is shown in approximate location next to the interface between the lid 14 and the container can portion 12. In this embodiment of safety-seal, the safety strap 60 must be removed the lid can be removed from the can portion 12. Therefore, the consumer knows that the lid has been removed at least once if the safe-strap 60 is removed.

The commercial significance of this invention is important. Although frozen dough has been sold for years. The typical way for such frozen dough to be sold is in a bulk size. In such case, the entire bulk sized “chunk” of dough must be thawed before the desired amount of dough can be removed. Then, the entire chunk has to be refrozen. The freezing and refreezing process, especially in containers that were not airtight, decreases the quality of the product. Although some manufacturers have sold dough in pre-portioned drop, none of those drops were placed in resealable airtight containers, let alone in a reusable plastic container as in the invention.

The plastic container has proven to be an attractive feature in the market place. The sidewall 50 can feature advertising indicia 52. In the alternative, decorative indicia, such as flower or other pleasing geometric or picture shapes and images can be added.

An especially important application of the invention is in the fundraising business. In the fundraising business, one common way of raising funds is to provide products to the school for sale by the students of the school. In such cases, the students are nearly always smaller than adults. Their hands are smaller and their capacity to carry things is more limited. Having containers, as opposed to awkward boxes, is the significant advantage in the sale of the product. Providing containers that are unbreakable and sturdy, such as the containers of the invention are significant advantage. The provision of a handle 24, further add to the utilitarian aspects of the container. Finally, the decorative or advertising indicia 52 can be customized for the school. For example, in the case of a school called “Cuyahoga Valley Christian Academy,” whose mascot or team names is “Royals,” the advertising indicia can be customized to place that schools name and logo on the container 10. The school would have a greater interest in using the fundraising company because of their ability to provide this special container. In addition, parents and friends of the school are more likely to purchase the product, knowing that they will be able to enjoy delicious cookies and, when the container is empty, the container provides a useful and decorative container for other purpose around the home or garage.

The invention has been described with reference to preferred embodiment. Obviously, modifications and alterations will occur to others upon a reading and understanding of this specification. It is intended to include all such modifications and alternations in so far as they come within the scope of the appended claims or the equivalence thereof.

Having thus described the invention, it is now claimed:

What is claimed is:

1. A method of packaging dough, Providing a container, said container being made of plastic and having a resealable opening;
Providing a lid, said lid cooperating with said container to selectively seal said container;
Separating uncooked dough into a plurality of drops;
Placing said plurality of drops into said container.

2. The method of claim 1 wherein said dough is frozen.

3. The method of claim 1 wherein said dough is cookie dough.

4. The method of claim 1 wherein said drops are sized to be a single portion of dough.

5. The method of claim 1 wherein said container further comprises:
A circular bottom having a radius RB; and,
A circular top edge having a radius RT, where RT is greater than RB.

6. The method of claim 1 wherein said container is a bucket.

7. The method of claim 1 wherein said dough is muffin dough.

8. A method of packaging frozen cookie dough,
Providing a container, said container being made of plastic and having a top edge and a bottom edge, said top edge of said container defining a circle with a radius RT, said bottom edge of said container defining a circle with a radius RB, with radius RT being greater than radius RB, said container having a resealable opening at the top edge of said container;
Providing a lid, said lid cooperating with said top edge of said container to selectively seal said container;
Separating uncooked, cookie dough into a plurality of drops, said drops being sized so to create a single portion cookie upon subsequent baking;
Freezing said drops;
Placing said plurality of drops into a bag;
Placing said bag containing said plurality of drops into said container, and, Sealing said container by connecting said lid to said top edge of said container in a generally air tight manner.

9. An article for containing frozen, pre-portioned dough, said article comprising:
A bottom, said bottom being generally circular and having a radius RB;
A top edge, said top edge extending between said top edge and said bottom, said sidewall being generally cylindrical;
being made of plastic and having a resealable opening;
a lid, said lid being removeably attachable to said top edge of said container, said lid cooperating with said top edge of said container to selectively seal said container;
Separating uncooked dough into a plurality of drops;
Placing said plurality of drops into said container.

10. The method of claim 9 wherein said dough is frozen.

11. The method of claim 9 wherein said dough is cookie dough.

12. The method of claim 9 wherein said drops are sized to be a single portion of dough.

13. The method of claim 9 wherein said container further comprises:
A circular bottom having a radius RB; and, A circular top edge having a radius RT, where RT is greater than RB.

14. The method of claim 9 wherein said container is a bucket.

15. The method of claim 9 wherein said dough is muffin dough.

16. A method of fundraising, the method comprising the steps of:
Providing a container, said container being made of plastic and having a top edge and a bottom edge, said top edge of said container defining a circle with a radius RT, said bottom edge of said container defining a circle with a radius RB, with radius RT being greater than radius RB, said container having a resealable opening at the top edge of said container;
Providing a lid, said lid cooperating with said top edge of said container to selectively seal said container;
Separating uncooked, cookie dough into a plurality of drops, said drops being sized so to create a single portion cookie upon subsequent baking;
Freezing said drops;
Placing said plurality of drops into said container;
Sealing said container by connecting said lid to said top edge of said container in a generally air tight manner; and,
Delivering said container to students for sale to supporters of the school.

17. A method of packaging dough,
Providing a container, said container being made of plastic and having a resealable opening;
Providing a lid, said lid cooperating with said container to selectively seal said container;
Separating uncooked dough into a plurality of drops;
Placing said plurality of drops into said container; and,
Selling said container to raise funds.

18. A method of baking a food product, the method comprising the steps of:
Providing a container, said container being made of plastic and having a resealable opening;
Providing a lid, said lid cooperating with said container to selectively seal said container;
Separating uncooked dough into a plurality of drops;
Placing said plurality of drops into said container;
Selectively removing a drop; and,
Baking said drop.
